(19) United States
(12) Patent Application Publication
(10) Pub. No.: US 2015/0235073 A1
(43) Pub. Date: Aug. 20, 2015

(54) FLEXIBLE PART-BASED REPRESENTATION FOR REAL-WORLD FACE RECOGNITION APPARATUS AND METHODS

(71) Applicant: THE TRUSTEES OF THE STEVENS INSTITUTE OF TECHNOLOGY, Hoboken, NJ (US)

(72) Inventors: Gang Hua, Livingston, NJ (US); Haoxiang Li, Hoboken, NJ (US)

(73) Assignee: THE TRUSTEES OF THE STEVENS INSTITUTE OF TECHNOLOGY, Hoboken, NJ (US)

(21) Appl. No.: 14/605,053

(22) Filed: Jan. 26, 2015

Related U.S. Application Data
(60) Provisional application No. 61/932,532, filed on Jan. 28, 2014.

(51) Int. Cl. G06K 9/00; G06K 9/62

(52) U.S. Cl. CPC G06K 9/00221; G06K 9/627; G06K 9/00288

(57) ABSTRACT

An automated face recognition apparatus and method employing a programmed computer that computes a fixed dimensional numerical signature from either a single face image or a set/track of face images of a human subject. The numerical signature may be compared to a similar numerical signature derived from another image to acertain the identity of the person depicted in the compared images. The numerical signature is invariant to visual variations induced by pose, illumination, and face expression changes, which can subsequently be used for face verification, identification, and detection, using real-world photos and videos. The face recognition system utilizes a probabilistic elastic part model, and achieves accuracy on several real-world face recognition benchmark datasets.

### CROSS-REFERENCES TO RELATED APPLICATION

The present application claims the benefit of U.S. Provisional Patent Application Ser. No. 61/932,532 filed on Jan. 28, 2014, the disclosure of which is incorporated herein by reference in its entirety.

### STATEMENT REGARDING FEDERALLY SPONSORED RESEARCH

Some of the research performed in the development of the disclosed subject matter was supported by Grant U.S. Pat. No. 1,350,763 from the U.S. National Science Foundation. The U.S. government may have certain rights with respect to this application.

### FIELD OF THE INVENTION

The present invention relates to face recognition apparatus and methods and, more particularly to apparatus and methods for automatic face recognition using a computer programmed with software capable of receiving at least two digital images of a person and making a comparison of those images to make a conclusion as to the identity of the persons depicted therein.

### BACKGROUND OF THE INVENTION

Face recognition systems currently exist, however, it remains a challenge for such systems to adequately account for changes in pose, illumination, and face expression changes. As real-world images and videos often present many changes in these elements, it is desired to provide a face recognition system which can adequately account for these changes.

Face recognition has remained an active research topic in computer vision for decades. In recent years, we have witnessed more and more research efforts on face recognition under uncontrolled settings. Face recognition can be categorized into two tasks: face identification and face verification. The former attempts to recognize the identity of a probe face based on a set of gallery face images with known identities. The latter tries to arbitrate if a pair of faces is from the same subject or not.

Currently more and more applications systems are exploiting face recognition technologies, and most of them, if not all, request a controlled environment. When dealing with face recognition in an uncontrolled emironment, various visual complications could affect the robustness of face recognition algorithms, such as changes in pose, illumination, expression, etc. Among these variations, pose variation is one of the most challenging, as shown in FIG. 1. Looking at the same person from different viewpoints, the appearance of the same face could vary a lot. As a result, large pose variation could heavily enlarge the intra-identity appearance difference to exceed the inter-identity variation which becomes an impediment for practical face recognition.

To address this problem, tens of years research have motivated many benchmarks and effective algorithims. In general, the ways in which the previous work on uncontrolled face recognition handle pose variation can be categorized into 4 kinds: (1) explicitly regularize pose changes; (2) align faces to relieve in-plane pose transformation; (3) use higher-level information; (4) build face part correspondence robust to pose variation. These are discussed in turn below.

A straightforward method to relieve the influence of pose changes is to explicitly regularize the pose difference. Prabhu et al. has proposed a pose-invariant face recognition algorithm using 3D generic elastic model. In their work, they generate am a per-identity 3D face model using a frontal enrollment face image. With the 3D face model, they could then synthesize 2D views under different poses for matching. Faces from different viewpoints could then be explicitly regularized using a 3D face model to the same pose for verification.

Yin et al dealt with pose variation in a similar manner by bridging two testing face images to the same pose. They collected a generic identity data set at the offline stage which presents appearance of the same identities under different intra-person settings (pose and illumination). In the testing stage, firstly the probe face is associated to an alike identity in the database. After that the algorithm predicts the new appearance of probe face under different intra-personal settings. Despite the intuitive motivation of these methods, one of their draw-backs are in the data collection step, which required non-trivial efforts to have a per-identity frontal enrollment face image or a generic identity dataset.

Another line of research in dealing with pose changes would be face alignment. In practice, pose changes could introduce two kinds of transformations: in-plane transformation and out-of-plane transformation. Face alignment algorithms usually transform faces into a nomalized pose through a similarity transformation on which one could handle the in-plane transformation. Cao et al. proposed a learning-based descriptor for face recognition which utilized descriptors extracted from fiducial points. Chen et al. also showed that by densely extracting high dimensional descriptors around face land marks could highly improve the face recognition performance.

As reported by Huang et al., a strong face alignment algorithm can be an effective preprocessing step for face recognition algorithms. However, building a face alignment system robust to different poses, illumination, expression and etc. by itself is a very challenging problem which requires a lot of engineering efforts. As a matter of fact, most state-of-the-art face alignment systems, even those with published papers, are often not fully accessible to the research community (an exception is the recent work of Xiong and De la Torre, who shared their code online). As a result, algorithms that require strongly aligned faces may not be practical when one wants to build an end-to-end functioning systems for face recognition. Moreover, face alignment algorithms by design are more effective in handling in-plane transformation, hence the residual misalignments after alignment could still affect the comparison between faces.

Currently, higher-level representations attract researchers' attention. In the area of face recognition, Kumar e al. proposed to use visual attributes to describe faces and to predict identities. Visual attributes are face appearance labels such as age, gender, jaw shape, nose size, etc. Since attributes are higher-level representations, they are robust to low-level appearance changes due to pose variations. However, in practice, collecting a sufficient number of attribute labels could be expensive and the pose variations could still have a negative influence since attributes of the testing image are inferred from the low-level image descriptors.

Without resorting to predefined 3D face models, fine-designed off-line database or expensive high-level representations, another line of research is to treat pose variant face recognition as an invariant matching problem, by exploiting a part based representation for a face, See, e.g., J, Wright and G. Hua, “Implicit elastic matching with randomized projections for pose variant face recognition” CVPR, 2009 and G. Hua and A. Akbarzadeh, “A robust elastic and partial matching metric for face recognition”, ICCV, 2009. Many of these robust matching algorithms are built on a part based representation of the face based on local image descriptors. The algorithms either explicitly identify the correspondences between part descriptors or implicitly build it when computing the part based representation for the face. Although by identifying how parts from two faces should be compared could not perfectly regularize the pose changes, it helps to handle both the in-plane and out-of-plane transformation.

Arashloo et al. proposed a method based on image matching with Markov random fields' model to conduct pose-invariant face recognition. In this method, in verifying two faces, one of them is deformed to match the other one by minimizing the energy of image matching. The algorithm achieved a state-of-the-art method in face identification without requiring face alignment. One disadvantage of this method is that the dense image matching with MRF model could be computationally expensive.

### BRIEF DESCRIPTION OF THE DRAWINGS

For a more complete understanding of the present invention, reference is made to the following detailed description of an exemplary embodiment considered in conjunction with the accompanying drawings, in which:

FIG. 1 is a set of sample facial image pairs of four different persons showing pose variations for each,

FIG. 2 is diagrammatic depiction of a processing flow of digital image data showing processing steps conducted in traversing a Spatial-appearance feature extraction pipeline,

FIG. 3 is diagrammatic depiction of a processing flow of digital image data showing processing steps conducted in traversing a pipeline of PEP-model based representation for face verification,

FIG. 4 is set of images corresponding to components in the PEP-model; each image of the set showing the average appearance and spatial location of a Gaussian component, each Gaussian component describing a facial part,

FIG. 5 is a a set of facial images, subportions thereof (as shown in the rectangles on the image) and examples for identifying the descriptors in building PEP representations,

FIG. 6 is a series of facial images that shows visualization of PEP-representations of face images in the following labeled rows: (a) testing faces present pose changes; (b) average appearance of the PEP-representations alleviated pose changes while suffering from occluded facial parts; (c) after horizontal flipping, the occluded facial parts are replace with symmetrical ones; and (d) without horizontal flipping, the PEP-representation evolves with 5, 10, 20, 50 frames (from left to right respectively) in a face track,

FIG. 7 is an illustration in which each column shows descriptors (shown as image patches) identified by the same Gaussian component. In both figures, the row above shows partial PEP-representations from face A in FIG. 3 and the bottom ones are from face B,

FIG. 8 is an illustration in which the effectiveness of spatial constraint is demonstrated: the bottom row is with spatial constraint, and the top row is without spatial constraint,

FIG. 9 is an illustration showing spatial distribution of 10 selected Gaussian components in the PEP-model over a face. Each ellipse (or circle) stands for a Gaussian component. The center and span show mean and variance of the spatial part of the Gaussian component.

FIG. 10 is a graph of true positive rate vs. false positive rate for different evaluation approaches applied to the most restricted LFW database.

FIG. 11 is a graph of true positive rate vs. false positive rate for different evaluation approaches is applied to the YouTube faces database.

FIG. 12 is a diagram of a computer system for implementing facial recognition methods in accordance with one embodiment of the present disclosure.

### SUMMARY OF THE INVENTION

In one aspect of the present disclosure, a programmed computer computes a fixed dimensional numerical signature from a single digital facial image or a set/track of face images from a human subject. This signature is invariant to visual variations induced by pose, illumination and face expression changes and can subsequently be used for face verification, identification, and detection, in real-world photos and videos. The face recognition system based on this model, utilizes a probabilistic elastic part model to achieve recognition accuracy using real-world, non-posed facial images datasets.

In another embodiment, a method for automatically categorizing a first digital image of a person and a second digital image of a person as either images of the same person or different persons using a computer programmed with digital processing software, includes the steps of: receiving the first digital image in the programmed computer as input to the digital processing software, the digital processing software partitioning the first digital image into a plurality of sub-parts, each having a plurality of pixels and a location relative to the first digital image, each pixel having a value corresponding to the appearance thereof on a scale of visual values; for each of the plurality of sub-parts of the digital image, extracting a local descriptor based upon the appearance of the sub-part; augmenting each local descriptor with its location in the first digital image, transforming the first image into a set of spatial-appearance descriptors; identifying one descriptor from the set of spatial-appearance descriptors to describe each part in a maximum likelihood sense; concatenating the appearance parts in the spatial-appearance descriptors in an order of the location components to build a probabilistic elastic part (PEP) representation of the first digital image; performing the preceding steps for the second digital image; calculating a similarity measure between the PEP representations of the first digital image and the second digital image to quantify the degree of similarity between the first image and the second image.

In another embodiment, the plurality of sub-parts are overlapping.

In another embodiment, further including the step of reproducing the first digital image at a plurality of scales.

In another embodiment, the local descriptor is a Local Binary Pattern (LBP).

In another embodiment, the local descriptor is a scale-invariant feature transform (SIFT).

In another embodiment, the visual values are greyscale values.

In another embodiment, the first digital image and the second digital image are facial images.

In another embodiment, the first digital image is a set of digital images and the steps A-F are conducted for each of the set of digital images.

In another embodiment, the set of digital images are a plurality of frames from a video clip.

In another embodiment, the first digital image includes a plurality of digital images and further including the step of training a Gaussian mixture model (GMM) with the spatial-appearance descriptors from the plurality of digital images.

In another embodiment, the each mixture component of the GMM is constrained to be a spherical Gaussian.

In another embodiment, the spherical Gaussians balance the impact of appearance and spatial location.

In another embodiment, further including the steps of obtaining a training set of images containing matching and non-matching facial image pairs; training an SVM classifier on the difference vectors associated with the training set of images; subsequently receiving new digital images into the computer; and distinguishing digital images of persons that match images of persons in the training set from digital images of persons that do not match images of persons in the training set.

In another embodiment, further including the step of classifying the first image as either the same person as a person appearing in the second image or a different person based upon the quantified similarity between the first image and the second image.

In another embodiment, the first digital image is a plurality of digital images of a single person.

In another embodiment, the plurality of digital images of the single person are images having differences in at least one of scale, pose, illumination or facial expression.

In another embodiment, further including applying a joint Bayesian adaptation to adapt the PEP-model to better fit the features of the pair of faces/face tracks by Bayesian maximum a posteriori parameter estimation.

In another embodiment, parameters of the PEP model may be learned using Expectation-Maximization (EM) from densely extracted spatial-appearance local descriptors from training face images.

In another embodiment, further including the step of constructing a horizontally flipped face image to be computed inot the PEP representation.

In another embodiment, the step of calculating a similarity measure is by training an SVM on top of an element-wise absolute difference vector of the PEP representations between the first digital image and the second digital image.

### DETAILED DESCRIPTION

Aspects of the present disclosure include face recognition apparatus and methods that account for changes in pose, illumination and face expression in images of the person subject to identification. The present disclosure presents a face recognition system capable of analyzing real-world images and videos captured without regard to pose, facial expression and illumination, which is also adequately flexible so that it can take into account new observations and factor out old representations. The present disclosure addresses the challenges to facial recognition which arise in the context of pose variant face verification under uncontrolled settings.

We propose another robust matching scheme to conduct pose-invariant face verification without requiring a strong face alignment component in H. Li, G. Hua, Z. Lin, J. Brandt and J. Yang, “Probabilistic elastic matching for pose variant face verification” in CVPR, 2013, which article is incorporated by reference herein in it's entirely. Therein a probabilistic elastic matching scheme is disclosed, which could handle both image-based, video-based or even mixed image-video based face verification in a unified framework. The probabilistic elastic matching is achieved based on a pose invariant face representation produced from a probabilistic elastic part (PEP) model.

The present disclosure presents a process and apparatus (software implementation of a new algorithm combined with a computing unit) to compute a fixed dimensional numerical signature from either a single face image or a set/track of face images from a human subject. This signature is invariant to visual variations induced by pose, illumination, and face expression changes, which can subsequently be used for face verification, identification, and detection, in real-world photos and videos. The face recognition system based on this model, namely probabilistic elastic part model, has achieved the top accuracy on several real-world face recognition benchmark datasets.

In accordance with the present disclosure, a probabilistic elastic part (PEP) model is used, which is a Gaussian mixture model (GMM) learned from a pool of local descriptors from all face images in the training corpus to capture the spatial-appearance distribution. Each mixture component of the GMM naturally defines a part. Given a face pair, the PEP-model builds a PEP representation for each face by sequentially concatenating part descriptors identified by each Gaussian component in a maximum likelihood sense. A difference vector is then calculated as the element-wise absolute difference between the two PEP representations. For face verification, we train an SVM on the difference vectors of all the feature pairs to decide if a pair of faces/face tracks is matched or not. We further propose a joint Bayesian adaptation algorithm to adapt the universally trained GMM to better model the pose variations between the target pair of faces/face tracks, which consistently improves face verification accuracy. Experiments show that the method achieved comparable performance to the state-of-the-art in the most restricted protocol on Labeled Faces in the Wild (LFW) and outperformed the best performance on YouTube video face database.

In our framework, each face is represented as a sequence of face part descriptors, through the PEP model. Contrary to where the part model is induced with heuristics, our PEP-model is automatically learned from data in a more principle way. With the PEP-model, we could build the PEP-representation for a face and conduct a robust matching between two faces without relying on strong face alignment algorithms. Moreover, our algorithm complements any state-of-the-art face alignment systems due to its capability in dealing with residual misalignments. Compared to other representations, the PEP-representation is more general in that a single face image or a face track could have an unified representation, i.e., the resulting vector representation is of the same dimension no matter whether the input is a single face image or multiple face images. This is especially compelling for video face verification as it does not need to conduct exhaustive pair-wise comparison of image frames.

In a first embodiment of the present disclosure, a computer may be programmed with software instructions that firstly takes a part based representation for a single digital face image or face track. Each digital face image is densely partitioned into overlapping patches at multiple scales. A local descriptor such as Local Binary Pattern (LBP) or scale-invariant feature transform (SIFT) is subsequently extracted. Each local descriptor is augmented with its location in the face image, and hence a face image is initially transformed to be a set of spacial-appearance descriptors. In the video-based face recognition, a face track is firstly transformed to be a set of spatial-appearance descriptors extracted from all video frames. After that, the PEP model identifies one descriptor from the pool to describe each part in a maximum likelihood sense.

To build the PEP-model for pose variant face verification, given a set of training images, the programmed computer trains a Gaussian mixture model (GMM) with the spatial-appearance descriptors from the training images. In speech recognition, such a GMM is also called Universal Background Model (UBM). In the framework of the present disclosure, each mixture component of the GMM is constrained to be a spherical Gaussian to balance the impact of the appearance and spatial location. As intuitively each Gaussian component in the GMM describes the appearance and spatial distribution of a kind of facial part, the GMM is named the probabilistic elastic part model (PEP-model).

In building the PEP-representation for a digital face image/face track, each component of the PEP-model identifies a spatial-appearance descriptor (extracted out-of an image patch) from the descriptors extracted from the face image or face track. The appearance parts in the identified descriptors are then concatenated in the order of the components to build the PEP-representation. The pose-invariance is introduced in the descriptors-election stage. Since a Gaussian component represents a facial part, it will consistently identify the spatial-appearance descriptor describing the facial part from the probe face with elastic robustness in appearance changes and spatial offsets. When matching two faces for face verification, the element-wise absolute difference vector between their PEP-representations represent the difference between the two faces.

An SVM classifier is then trained on the difference vectors given a set of training matching/non-matching face/face track pairs, which is subsequently used to verify any new face/face track pairs. Since the PEP-model builds a consistent form for a pair of face images or face tracks, the matching framework can be used for both image-to-image and video-to-video face verification without any modification.

As shown in experiments, the proposed robust matching with the probabilistic elastic part model, namely probabilistic elastic matching (PEM), achieved state-of-the-art performance on the LFW (working under the most restricted protocol) and outperformed top algorithms on the YouTube Video Face Dataset. To make PEM to be adaptive to each pair of faces, we further propose a joint Bayesian adaptation scheme to adapt the PEP-model to better fit the features of the pair of faces/face tracks by Bayesian maximum a posteriori parameter estimation.

We call such an adapted matching programmatic algorithm to be adaptive probabilistic elastic matching (APEM). APEM adapt the universally trained PEP-model to each face pair to biased the Gaussian components to the spatial-appearance subspace spanned by the face pair to help build PEP-representation more robust to pose changes. Hence it can achieve better verification accuracy. In our experiments, it consistently improves the face verification performance over PEM at the cost of additional computation. Our experiments even show that our PEM and APEM algorithms, when applied to face verification with unaligned faces, i.e., raw face images extracted from the Viola-Jones face detector, could achieve decent performance or even outperform some state-of-the-art algorithms, such as the bio-inspired V1 features with multiple kernel learning applied to faces aligned with the funneling method under the most restricted protocol in LFW. This provides strong evidence that our PEM and APEM algorithms can better handle pose variations.

Hence, 1) we propose to use a universally trained PEP-model on spatial-appearance features as a bridge to build pose-invariant PEP-representations for both image and video face verification; 2) we show that the joint Bayesian adaptation of the PEP-model on the pair of faces/face tracks to be verified can further improve the matching; and 3) we achieve state-of-the-art face verification accuracy on both LFW (the most restricted protocol in image restricted setting), and the YouTube Faces benchmarks.

The GMM for visual recognition and the current state-of-the-art face verification algorithms and YouTube video face datasets are now discussed. The Gaussian mixture model may be used for various visual recognition tasks including face recognition and scene recognition. While one may focus on modeling the holistic appearance of the face with GMM, one may also exploit the bag of local descriptors representation and use GMM to model the local appearances of the image. In their frameworks, a GMM is the probabilistic representation of an image. Then the GMM is encoded into a super-vector representation for classification. As used, the universally trained GMM is a probabilistic general representation of human face; each Gaussian component models the spatial-appearance distribution of a facial part. In terms of model adaptation, utilizations may also leverage the GMM and Bayesian adaptation paradigm to learn adaptive representations, wherein the super-vector representations are adopted for building the final classification model. In accordance with an embodiment of the present disclosure, joint spatial-appearance modeling may be conducted using spherical Gaussians as the mixture components and their Bayesian adaptation is applied to a single image in contrast to conducting a joint Bayesian adaptation on a pair of faces/face tracks to better build the correspondences of the local descriptors in the two face images/face tracks.

One of the specialties of the PEP-model is the spherical Gaussian components, which explicitly address the unbalanced dimensionality between appearance and spatial constraint for a spatial augmented descriptor. A GMM with regular Gaussian components trained over the special appearance features may not be desirable for building the PEP-model because face structures can be similar in appearance but vary spatially, e.g., left eye and right eye, could be mixed into the same Gaussian component under weak spatial constraint, as the dimensionality of spatial location is relatively smaller comparing to the size of the appearance descriptor. If a GMM with spherical Gaussian component is used as a PEP-model, the strength of spatial constraint can be tuned by scaling the location units which help balance the influence: of appearance and spatial constraint in learning the facial parts.

Previous works on image-based face verification mostly reported their performance over the Labeled Face in the Wild dataset (LFW). The LFW benchmark has three protocols in the Image-Restricted Training setting for a 10 fold cross validation evaluation. The most restricted protocol does not allow any additional datasets to be used for face alignment, feature extraction, or building the recognition model. The less restricted protocol allows use of additional datasets for face alignment and feature extraction, but not for building the recognition model. While the least restricted protocol allows additional datasets to be exploited for all three tasks. The current state-of-the-art on the most restricted protocol is the work of the fisher vector faces presented by Simonyan et al., which achieved an average accuracy of 0.8747±0.0149.

Predominant recent works focused on the less restricted protocols and least restricted protocols, which have pushed the recognition accuracy to be as high as 0 9517±0.0113. They leveraged additional data sources or strong face alignment algorithms trained from external data sources. We focused our experiments on the most restricted protocol on LFW as our interest is the design of a robust matching method for pose variant face verification. Besides the fact that our method does not exploit any outside training data or side information, the method of the present disclosure, on one hand is flexible to local descriptor choices that it could benefit from special local descriptors; on the other hand it could address residual misalignments so that it can complement and benefit from a strong face alignment system. Restricting the evaluation to the most restricted protocol enables objective evaluation of the capacity of our proposed part model and representation. Our method only employed simple visual features such as LBP and SIFT. We also observed consistent improvement when fusing the results from these two types of features together, suggesting that we can further improve face verification accuracy from the proposed method by fusing more types of features, or by feature learning.

While a number of state-of-the-art methods on LFW may not be applied to video-based face verification directly, our work can handle the video-based setting without modification. Wolf et al. published a video face verification benchmark, namely YouTube Faces is widely recognized and evaluated these years. There can be various ways to interpret the video-based setting. Wolf et al. treat each video as a set of face images and compute set-to-set similarity; Zhen et al. takes an spatial-temporal block based representations for each video and utilize multiple face region descriptors with a metric learning framework; in the framework of the present disclosure, we have a consistent PEP-representation for both video and image. Without exploiting temporal information or extra reference dataset, our method uses the PEP-model to build pose-invariant representation and hence identify local correspondences between face parts across frames. Our algorithm outperformed the state-of-the-art methods on the YouTube faces dataset.

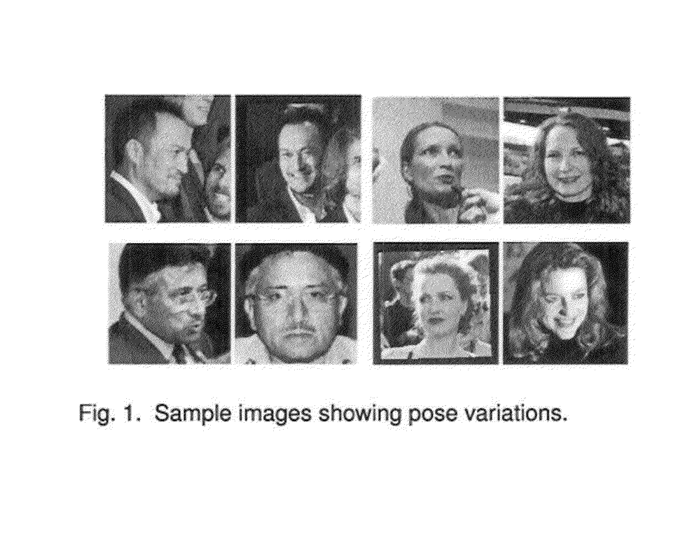

According to an embodiment of the invention, the probabilistic elastic part (PEP) model is employed. The PEP model learns a spatial-appearance (i.e., a local descriptor augmented by its location in the face image) Gaussian mixture model. By constraining Gaussian components to be spherical, the PEP model balances the impact of spatial and appearance parts, and forces the allocation of a Gaussian component to each local region of the image. Given densely extracted spatial-appearance local descriptors from training face images, parameters of the PEP model may be learned using Expectation-Maximization (EM). The third column of FIG. 1 shows some of the Gaussian PEP components learned from the Labeled Faces in the Wild Database. The PEP model effectively handles pose variations based on a part based representation, and accounts for variations from other factors using invariant local descriptors.

FIG. 1 illustrates the process of producing the PEP representation for either a face image or a set/track of face images. Each Gaussian component (representing a face part) of the model selects the local image descriptor with the highest likelihood for that component. For example, if a particular Gaussian component tends to model nose-like patterns, then the chosen patch will tend to be on the subject's nose. The final representation is a concatenation of the selected descriptors from all components (i.e., all face parts). Since the position of patches is part of the descriptor, the chosen descriptor must come from a region near the component's mean. Where k=face parts of dimension d (i.e., k Gaussian components), the descriptor describing the entire face has k×d elements. For example, if a scale-invariant feature transform (“SIFT”) descriptor (d=128 dimensional byte vector) and k=1024 Gaussian component are used, the final PEP representation of a face (either from a single face image or a set/track of face images) would be about 128 k bytes in length.

The PEP representation presents numerous advantages when compared with existing part based representation for face recognition, for instance, the parts of the PEP model are automatically learned from data instead of hand-crafted. Additionally, the PEP model generates a single fixed-dimension representation given a varying number of face images from a subject. It unifies image and video based face recognition in a single representation. Here, the only difference is that in the video case, the maximum likelihood part descriptor is identified from all video frames. Further, when building the representation from multiple face images, e.g., a track of face images from a video, the PEP representation integrates the visual information from all of these face images together instead of selecting a single best frame to produce it.

Moreover, the PEP representation is additive, i.e., when additional face images of one specific person are available, the representation can be updated without revisiting the images that produced the original representation. This stems from the property of the max operation when identifying the maximum likelihood part descriptors, which can naturally be incrementally performed. Also, when applied for face identification, the PEP representation allows the gallery face database to scale linearly with the number of subjects, instead of number of images.

### Feature Extraction

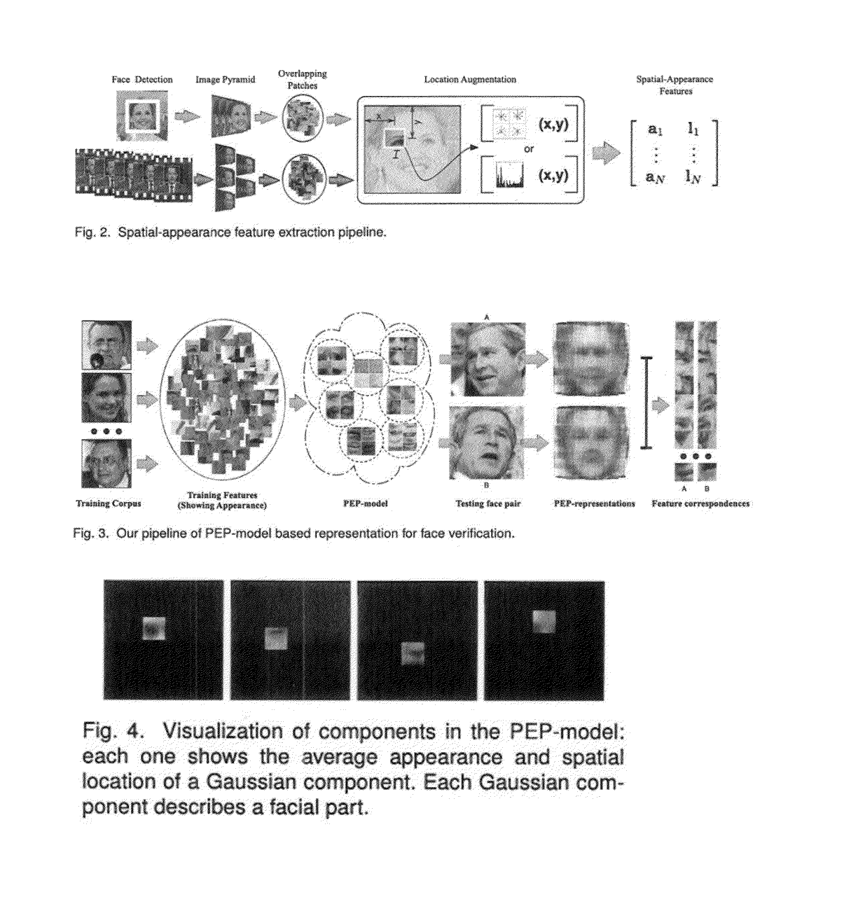

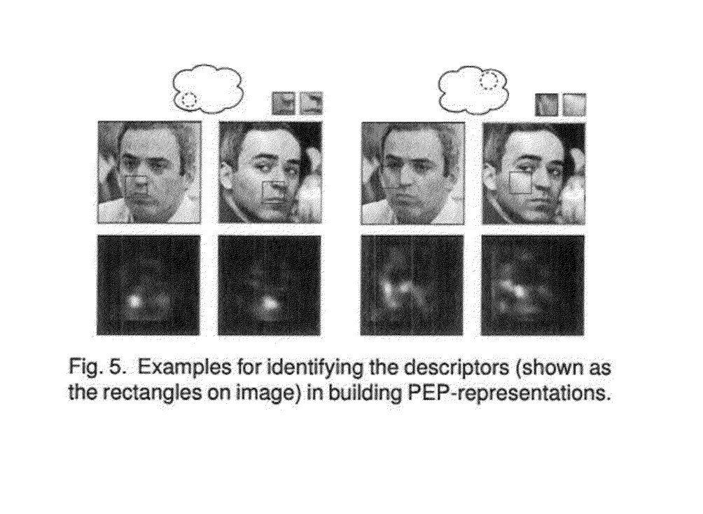

For image based face verification, we represent each face image as a set of spatial-appearance descriptors. As shown in FIG. 2, for each face image [symbol] , we firstly build a three layer Gaussian image pyramid. Then we densely extract overlapping image patches from each level of the image pyramid. The set of all [symbol] patches extracted from a face image [symbol] is denoted as [symbol] ={pᵢ}ᵢ₌₁^{N}. After that, we extract local appearance descriptor from each image patch pᵢ which we denote as aₚᵢ. Finally, we augment the appearance descriptor of each patch pᵢ with its coordinates 1pᵢ=[x y]^{T} as its spatial descriptor. As a result, the final description for a patch pᵢ is a spatial-appearance descriptor

$${f}_{pi} = {[ a \frac{T}{{p}_{i}} , 1 \frac{T}{{p}_{i}} ]}^{T} .$$

The face image [symbol] is hence initially transformed into an ensemble of these spatial-appearance descriptors, i.e., f [symbol] {fₚᵢ}ᵢ₌₁^{N}.

In video based face verification, the task is to verify if two tracks of faces are from the same person or not (assuming each track of faces is the face of a single person). We adopt the same part-based representation for a face track by repeating the feature extraction pipeline in FIG. 2 on each face image in the track. The descriptors extracted from all the face images from a single track are put together to form a larger set of spatial-appearance descriptors to serve as the initial characterization of a face track. As a result, we take the same kind of part-based representation for both image based and video based face verification. Therefore the PEP-model and the elastic matching method we will introduce in the following sections will apply to both image and video based face verification, as shown in FIG. 2.

### Probabilistic Elastic Part Model

The exact steps of the proposed probabilistic elastic matching method are illustrated in FIG. 3 which consists of the PEP-model training and PEP-representation building. We start by building a GMM from all the spatial-appearance descriptors extracted from face images in the training set. As each Gaussian component describes a facial part, we call such a GMM a PEP-model.

Given a face/face track pair, both of which are represented as a set of spatial-appearance descriptors, we build PEP-representation for each face. Given one of the faces/face tracks, for each Gaussian component in the PEP-model, we identify a spatial-appearance descriptor by looking for the one induces the highest probability on the Gaussian component. We concatenate the descriptors identified by Gaussian components to build the PEP-model for a face/face track. In this process, given a face pair, the descriptors identified by the same Gaussian component should be from the same facial part. We call such a pair of descriptors a corresponding feature pair. The absolute element-wise difference vectors between two PEP-representations incorporated comparisons between all corresponding feature pairs, which is subsequently fed into an SVM classifier for prediction.

An additional improvement is to conduct a joint Bayesian adaptation step to adapt the PEP-model to the union of the spatial-appearance descriptors from both face images/tracks constrained a priori by the parameters of the original PEP-model to form a new adapted PEP-model (APEP-model). Then we could use the APEP-model instead of the universally trained PEP-model to build the PEP-representations. Since the probabilistic distribution described by the APEP-model is biased towards the spatial-appearance subspace spanned by face pair jointly, as a result, the feature correspondences built by APEP-model are more accurate.

We call the proposed approach using universally trained PEP-model to conduct elastic matching to be probabilistic elastic matching (PEM), and the approach using APEP-model to build the corresponding feature pairs to be adaptive probabilistic elastic matching (APEM). We proceed with detailed description of the key steps including the training of the PEP-model (Section 4.1), the building of PEP-representation (Section 4.2), the joint Bayesian adaptation algorithm for the APEM (Section 4.3) and a straightforward multiple feature fusion framework (Section 5).

### 4.1 Universally Training PEP-Model

As we have mentioned, universally trained GMM is widely used in the area of speech recognition[31]. In our method, to balance the impact of the appearance and spatial location, we confine the GMM to be with spherical Gaussian components, i.e.,

$$P ( f \vert Θ ) = {\sum }_{k = 1}^{K} {ω}_{k} 𝒢 ( f \vert {\vec{μ}}_{k} , {σ}_{k}^{2} I ) , \qquad ( 1 )$$

where Θ=(ω₁,\vec{μ}₁, σ₁, . . . , ω_{K}, \vec{μ}_{K}, σ_{K}); K is the number of Gaussian mixture components; I is an identity matrix; ωₖ is the mixture weight of the k-th Gaussian component; [symbol] (μₖ,σₖ² I) is a spherical Gaussian with mean μₖ and variance σₖ²I, and f is an m-dimensional spatial-appearance feature vector i.e., f=[a^{T}1^{T}]^{T}.

To fit such a GMM over the training set X={f₁, f₂, . . . , f_{M}}, we resort to the Expectation-Maximization (EM) algorithm to obtain an estimate of the parameters of GMM by maximizing the likelihood [symbol] of the training descriptors [symbol] formally,

$${Θ}^{*} = arg {max}_{Θ} ℒ ( χ \vert Θ ) \qquad ( 2 )$$

The EM algorithm consists of the E-step which computes the expected log-likelihood and the M-step which updates parameters to maximize this expected log-likelihood [41]. Specifically, in our case, in the E-step, we calculate

$$\begin{matrix}{n}_{k} = {\sum }_{i = 1}^{M} P ( k \vert {f}_{i} ) & ( 3 ) \\ {E}_{k} ( f ) = \frac{1}{{n}_{k}} {\sum }_{i = 1}^{M} P ( k \vert {f}_{i} ) {f}_{i} & ( 4 ) \\ {E}_{k} ( {f}^{T} f ) = \frac{1}{{n}_{k}} {\sum }_{i = 1}^{M} P ( k \vert {f}_{i} ) {f}_{i}^{T} {f}_{i} , & ( 5 )\end{matrix}$$

where P(k|fᵢ) is defined as

$$P ( k \vert {f}_{i} ) = \frac{{ω}_{k} 𝒢 ( {f}_{i} \vert {μ}_{k} , {σ}_{k}^{2} I )}{{\sum }_{{k}^{′} = 1}^{K} {ω}_{{k}^{′}} 𝒢 ( {f}_{i} \vert {μ}_{{k}^{′}} , {σ}_{{k}^{′}}^{2} I )} \qquad ( 6 )$$

which is the posterior probability that the k-th Gaussian component generated feature fᵢ, In the M-step, the parameter set Θ is updated as

$$\begin{matrix}{\hat{ω}}_{k} = \frac{{n}_{k}}{M} , & ( 7 ) \\ {\hat{μ}}_{k} = {E}_{k} ( f ) , & ( 8 ) \\ {\hat{σ}}_{k}^{2} = \frac{1}{m} ( {E}_{k} ( {f}^{T} f ) - {\hat{μ}}_{k}^{T} {\hat{μ}}_{k} ) . & ( 9 )\end{matrix}$$

These two steps are iterated until convergence, at which time we obtain the GMM. Note that variances along different dimensions are indeed taken into consideration through Equation 9.

As shown in FIG. 4, each Gaussian component is the universally trained GMM captured the spatial-appearance distribution of a facial part. We call the GMM probabilistic elastic part model (PEP-model). We will discuss the influence of spatial constraint as well as the motivation to use spherical Gaussian components in Section 4.4.

### 4.2 PEP-Representation

After we obtained the K-components PEP-model trained over training spatial-appearance descriptors, we exploit it to form a PEP-representation in the form of a D=mₐ×K dimensional vector for a face image/track, where mₐ is the dimensionality of the appearance descriptor, e.g., LBP or SIFT.

Formally, we first transform a face/face track [symbol] to a set of spatial-appearance descriptors f_{F}={f₁, f₂, . . . , f_{N}}.

First we let each Gaussian component (ωₖ, [symbol] ₖ(\vec{μ}ₖ, σₖ²I)) commit one descriptor f_{gk}(F) from f_{F}, such that

$${ℊ}_{𝓀} ( ℱ ) = arg {max}_{i} {ω}_{k} 𝒢 ( {f}_{i} \vert \vec{μ} , {σ}_{k}^{2} I ) \qquad ( 10 )$$

The face/face track [symbol] is then represented as a sequence of K mₐ-dimensional descriptors, i.e, [a_{g1} a_{g2} . . . a_{gk}], which is the PEP-representation of [symbol] . Note in this representation, we keep only the appearance descriptors since the spatial components are already taken into consideration in the descriptor selection stage (Equation 10). As shown in FIG. 4.2, given a Gaussian component and a face, the Gaussian component as a facial part model locates the spatial-appearance descriptor with the highest probability. As shown in the gray-scale visualization, the intensity of a pixel indicating the probability of the spatial-appearance descriptor over the Gaussian distribution. Following Equation 10, the brightest point on the face identifies the descriptor from the facial part. As shown in FIG. 4.2, the same Gaussian component identifies descriptors from the same facial part. As long as the comparisons between faces are within the same facial parts, the pose variation can be alleviated.

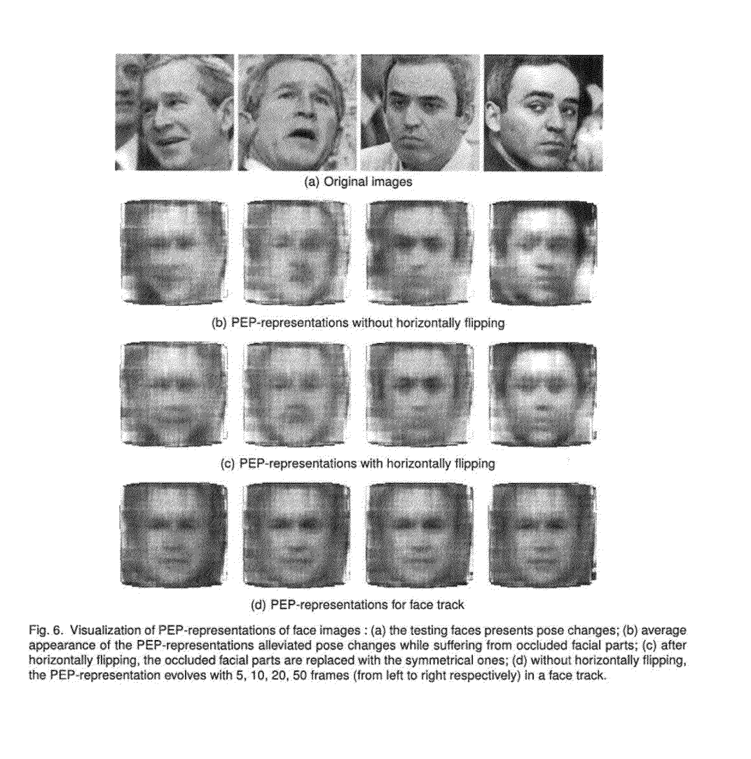

To present intuitive understanding of the PEP-representation, we visualize the PEP-representations by aligning the image patches associated with the selected descriptors to the mean locations of the facial parts, as shown in FIG. 6. We simply take averaged pixel values for the overlapped regions. As we can observe, the pose changes is alleviated in the PEP-representations. By incorporating a horizontally flipped face image in the representation similar to [39], we can build an even more pose-invariant PEP-representations by replacing the oc-cluded facial parts in profile faces with the symmetrical ones on the other side, which are further evaluated in our experiments.

With the PEP-representations, given the i-th faces/face tracks pair ( [symbol] and [symbol] ′), we take the difference of the two vectors produced from the PEP-representations, i.e.,

dᵢ=[Δa_{g1} Δa_{g2} . . . Δa_{gk}]T (11)

where Δa_{gk}=|a_{gk(F)}−Δa_{gk(F′)}|^{T}, which serves as the matching vector of a pair of faces/face tracks for face verification.

After building the representations for all the training pairs, a kernel SVM classifier, i.e.,

$$f ( d ) = {\sum }_{i = 1}^{V} {a}_{i} k ( {d}_{i} , d ) + b , \qquad ( 12 )$$

is then trained over C training difference vectors {d₁, d₂, . . . , d_{c}} with the Gaussian Radial Basis Function (RBF) kernel, i.e.,

k(dᵢ,dⱼ)=exp(−γ∥dᵢ−dⱼ∥²),γ>0, (13)

where i, j=1, . . . , C. Given the difference vector dₜ of a testing face/face track pair, the SVM predicts its label.
We employed the LibSVM [42] to train the SVM classifier. We call the overall matching algorithm using PEP-model to be probabilistic elastic matching (REM).

### 4.3 Joint Bayesian Model Adaptation

Prior work applying GMMs with Bayesian adaptation to visual recognition [33], [34] has operated either at the class level or at the image level. To make the matching process adaptive for each face/face track pair, we propose a joint Bayesian adaptation on the union of the bag of spatial-appearance descriptors from the faces/face tracks pair. In the joint adaptation process, the parameters of the universally trained GMM build the prior distribution for the parameters of the jointly adapted GMM under a Bayesian maximum a posteriori (MAP) framework.

We denote the universally learned GMM parameter set as Θ_{b} and parameter set of the GMM after joint adaptation as Θ_{p′}, where Θₓ={ωₓ₁, \vec{μ}ₓ₁, σₓ₁, . . . , ω_{xK}, \vec{μ}_{xK}, σ_{xK}}, x={b,p}. Given a face/face track pair [symbol] and [symbol] , the adaptive GMM is trained over the joint descriptor set [symbol] ={f₁, f₂, . . . ,fₖ} which is the union of descriptor sets of [symbol] and [symbol] as [symbol] _{q} and [symbol] ₛ, where | [symbol] ₚ|=| [symbol] _{q}|+| [symbol] ₛ|. Upon [symbol] ₚ, a MAP estimate for Θₚ, can be obtained by maximizing the log-likelihood [symbol] (Θₚ),

[symbol]

(Θₚ)=InP(xₚ|Θₚ)+InP(Θₚ|Θₖ). (14)

The conjugate prior distribution of Θₚ is composed from the PEP-model parameter Θ_{b} [33], [34], [41], i.e.,

(ωₚ₁, . . . ,ωₚₖ)˜Dir(Tω_{b1}, . . . ,Tω_{bk} (15)

μₚₖ˜ [symbol] (\hat{μ}_{bk},σ_{bk}²/γ (16)

The prior distribution over the mixture weights is a Dirichlet distribution. The parameter T can be interpreted as the count of descriptors introduced by the universally learned model. The prior distribution for mean μₚₖ is a spherical Gaussian distribution with variance smoothed by parameter γ. We can also use a Normal Wishart distribution over the variance as in [34], [41]. However, in order to stabilize the adapted GMM, we confined the adapted variance to be the same as that of the universal model, i.e., σₚₖ²=σ_{bk}²

With these priors, the parameters of the adapted GMM can be estimated by a Bayesian EM algorithm [33], [34], [41], i.e., in the E-step, we calculate

$$\begin{matrix}{n}_{k} = {\sum }_{i = 1}^{P} P ( k \vert {f}_{i} ) , & ( 17 ) \\ {E}_{k} ( f ) = \frac{1}{{n}_{k}} {\sum }_{i = 1}^{P} P ( k \vert {f}_{i} ) {f}_{i} , \\ where & ( 18 ) \\ P ( k \vert {f}_{i} ) = \frac{{ω}_{{p}_{k}} 𝒢 ( {f}_{i} \vert {μ}_{{p}_{k}} , {σ}_{{p}_{k}}^{2} )}{{\sum }_{{k}^{′} = 1}^{K} {ω}_{{p}_{k}} , 𝒢 ( {f}_{i} \vert {μ}_{{p}_{k}} , {σ}_{{p}_{k}^{′}}^{2} )} , & ( 19 )\end{matrix}$$

and in M-step, we update Θₚ as

$$\begin{matrix}{\hat{ω}}_{p k} = α \frac{{n}_{k}}{N} + ( 1 - α ) {ω}_{bk} , & ( 20 ) \\ {\hat{μ}}_{p k} = {β}_{k} {E}_{k} ( f ) + ( 1 - {β}_{k} ) {\vec{μ}}_{bk} , & ( 21 )\end{matrix}$$

where

a=N/(N+T),βₖ=nₖ/(nₖ+γ) (22)

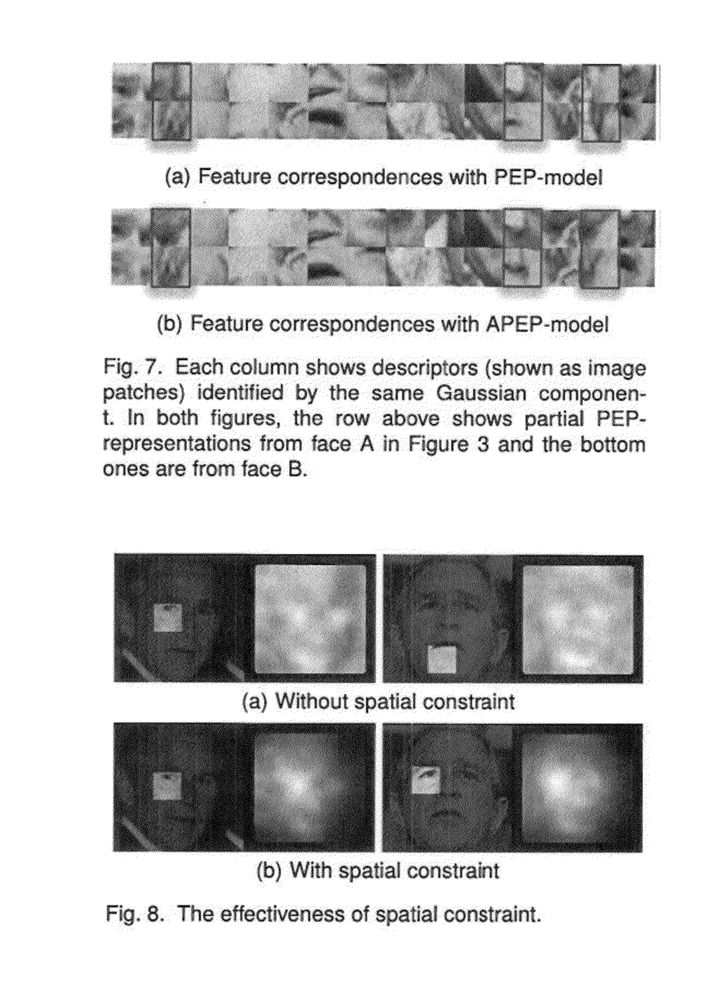

The adapted GMM can be interpreted as a mixture of facial part models as the universally learned PEP-model. In our framework, we name the adapted GMM as APEP-model following the same terminology. After we obtain the APEP-model given a pair of faces/face tracks, we conduct APEM to build the PEP-representations and difference vector. We could observe APEM improved some feature correspondences as shown in FIG. 7, as shown in the highlighted columns.

### 4.4 Spatial Constraint

As we shown in Section 4.2, the PEP-representations i.e., feature correspondences are the key to handle the pose variations. How well could the spatial-appearance descriptor from the same facial part be located by a Gaussian component highly relied on the construction of the PEP-model. The Gaussian distribution affects the responses as shown in FIG. 7. In our framework we incorporate spatial constraint in building the PEP-representations by augmenting spatial locations to the local appearance descriptors. The constraint takes effect in the PEP-model training step and the PEP-representations building step by altering the responses of descriptors over the spherical Gaussian component (Equation 10).

From the visualization (FIG. 8) we can observe how the spatial constraint helps in building the PEP-representation. The highlighted patches locate the local descriptors with highest probabilities over the Gaussian component. As shown in the top row, in lack of spatial constraint, the responses is more fuzzy and therefore failed to locate two comparable local descriptors which are from the same facial part; while in the row below, with augmented spatial constraint, the enforced locality takes effects and help locate a desired comparison.

Obviously, the strength of spatial constraint plays an important role in the PEP-model learning as well as the PEP-representation building step. With the location augmented descriptor, it is a well-recognized problem that the spatial constraint from the augmented 1 can be too weak to make a difference. Because in practice the dimension mₐ, of the appearance feature a can be considerably larger than the dimension of the location feature 1 which is mₗ=2 in our experiments.

Here we argue and demonstrate that confining each mixture component in PEP-model to be a spherical Gaussian can help address this issue, as it establishes a balance between the spatial and appearance constraint. Take the k-th Gaussian component P (f|ωₖ, μₖ, σₖ²I) as an example, the generative probability of descriptor f is

$$𝒢 ( f \vert {\vec{μ}}_{k} , {σ}_{k}^{2} I ) ∝ e - \frac{{‖ a - {\vec{μ}}_{k}^{a} ‖}^{2}}{2 {σ}_{k}^{2}} e - \frac{{‖ 1 - {\vec{μ}}_{k}^{l} ‖}^{2}}{2 {σ}_{k}^{2}} , \qquad ( 23 )$$

where \vec{μ}ₖ^{a} and \vec{μ}ₖ^{l} are the appearance and location part of \vec{μ}_{k′}, respectively, such that \vec{μ}ₖ=[\vec{μ}ₖ^{a}^{^{T}}, \vec{μ}ₖ^{l}^{^{T}}]^{T}. As shown in Equation 23, the spherical Gaussian on the spatial-appearance model can be regarded as the product of two equal variance Gaussian distribution over two Euclidean distances produced by the appearance and location, respectively. As long as the ranges of the two Euclidean distances are matched, the influence of these two Gaussians will be balanced. This can be easily achieved by normalizing the appearance and the location part of the spatial-appearance descriptors in an appropriate way, such as scaling a to be an unit vector and elements of 1 within the range 0 to 1.

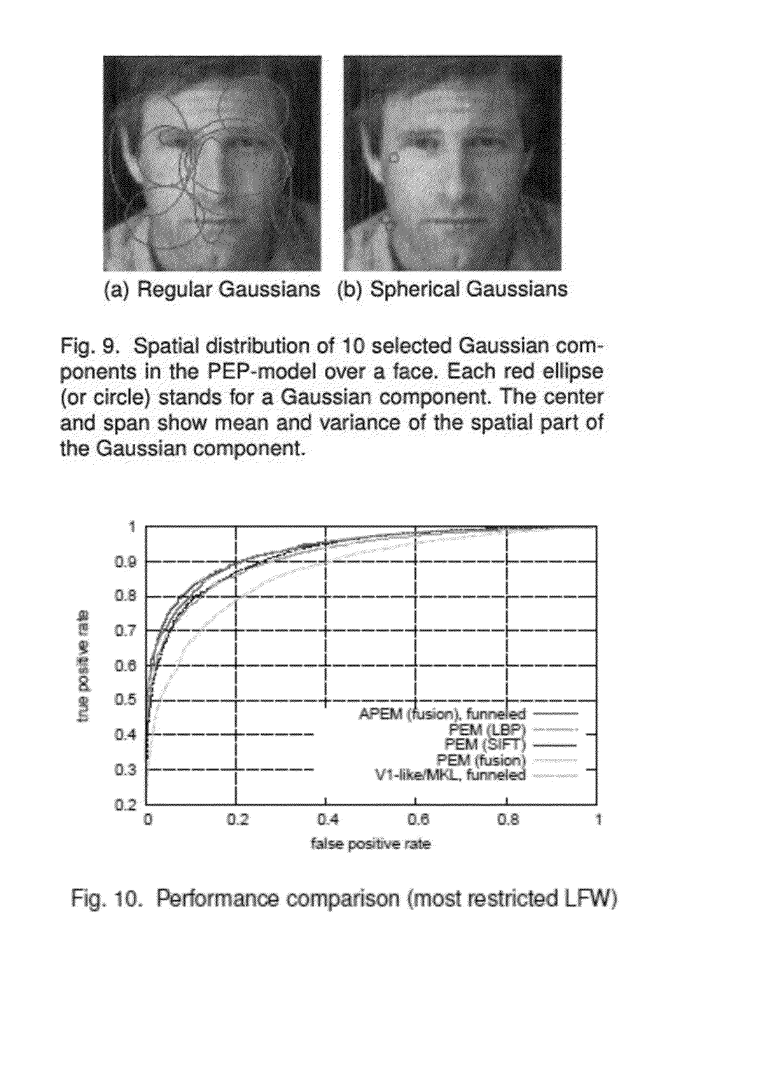

As illustrated in FIG. 9, without confining the mixture components to be spherical Gaussians, the spatial constraint introduced by 1 is so weak that the spatial spanning of Gaussian components are highly overlapped, which could not help build correct feature correspondences in PEP-representations. In contrast, the spatial variances of spherical Gaussian components are more localized, which could tolerate pose variations more appropriately.

Note that if the PEP-model is with regular Gaussian components, one can not address this issue by scaling a. This can be observed by checking the equations in the EM algorithm: if a is scaled, the corresponding means and covariances will be scaled proportionally. Then the probability of f over each of the Gaussian components will be scaled in the same way. As a result, P(k|fᵢ) is unchanged (Equation 6), which means the EM estimates will undesirably remain the same—it only scales the mean and variance estimates. This is not able to help balance the influence of the appearance and the location.

### 5 Multiple Feature Fusion

In visual recognition, different kinds of multiple feature fusion techniques are widely adopted [8], [13]. In this paper, we augment our PEM/APEM by a simple multiple feature post-fusion framework to combine the effectiveness of different features using a linear SVM.

To post-fuse multiple features, we repeat the proposed pipeline over all face/face track pairs using D types of different local descriptors to obtain D confidence scores for each face/face track pair pᵢ as a score vector

sᵢ=[sᵢ_{₁},sᵢ_{₂} . . . Sᵢ_{_{D}}], (24)

where sᵢ_{_{d}} denotes the score assigned by the classifier using the d-th type of descriptor. Over all C training score vectors {s₁, s₂, . . . , s_{c}} and their labels, we train a linear SVM classifier to predict the label for a testing score vector sₜ of a face/face track pair. Such a simple scheme proved to be very effective in our experiments. We note here that more advanced method such as multiple kernel learning (MKL) similar to what has been adopted in [8] can also be adopted, but we observe no performance difference when compared with our simple fusion scheme with a linear SVM.

### 6. Experimental Evaluation

Extensive experiments were performed over two challenging datasets, Labeled Face in the Wild (LFW) [14] and YouTube Faces Database[15].

### 6.1 Horizontally Flip Image

Considering the face that human faces are symmetric in general, we generate a horizontally flipped version of for every image in the dataset. As the proposed framework could handle face and face track in a unified representation, a single face image under this setting will be regarded as a two frames video from symmetric viewpoints. Unlike previous work using the same technique [39] which need to repeat the same pipeline over the four possible combinations between flipped and original faces and take the average distance as the measurement, PEP-representation is more suitable in utilizing the flipped face by simply replacing the occluded facial parts with the ones from the flipped faces, as shown in FIG. 6, We simply add the descriptors from the flipped image to the descriptor set of the face and it could help build feature correspondence in presence of occluded facial parts.

### 6.2 Labeled Faces in the Wild

Labeled Faces in the Wild (LFW) [14] dataset is designed to help address the unconstrained face verification problem. This challenging dataset contains more than 13,000 images from 5749 people. In general there are two training methods over LFW, image-restricted method and image-unrestricted method. By design, image-restricted paradigm does not allow experimenters to use the name of a person to infer two face images are matched or non-matched, while in the image-unrestricted paradigm experimenters may form as many matched or non-matched face pairs as desired for training. Over LFW, researchers are expected to explicitly state the training method they used and report performance over 10-folds cross-validation. In our experiments, we followed the most restricted protocol, in which detected faces are aligned with the funneling method [43].

### 6.2.1 Baseline Algorithm

To better investigate our PEM/APEM approach to pose variant face verification, we introduce a baseline algorithm that shows how well a trivial location-based feature pair matching scheme performs. The baseline algorithm provides a basis of comparison to evaluate the effectiveness of the PEP-model or adapted PEP-model. Formally, [symbol] and [symbol] ′ are representations of two faces, both have [symbol] descriptors, i.e., [symbol] ={f₁ . . . f_{N}} and [symbol] ′={f₁′ . . . f_{N}′}, where fₙ and fₙ′ are two spatial-appearance descriptor from the n-th local patch at the same location. Similar to Section 4.2, the difference vector between faces [symbol] and [symbol] ′ is d( [symbol] , [symbol] ′)=[|f₁−f₁′|^{T} . . . |f_{N}−f_{N}′|_{T}]_{T}. Then we train an SVM classifier over training difference vectors to predict if a testing face/face track pair is matched.

### 6.2.2 Settings

In our experiments, images are center cropped to 150×150 before feature extraction. As shown in FIG. 2, SIFT and LBP features are extracted over each scale for a 3-scale Gaussian image pyramid with scaling factor 0.9. SIFT features are extracted from patches from a 8×8 sliding window with 2-pixel spacing, and LBP descriptors are extracted from a 32×32 sliding window with 2-pixel spacing. The LBP descriptor is constructed in a part-based scheme by partitioning each window uniformly into 16 8×8 cells and concatenating 16 58-dimensional uniform LBP histogram [44] calculated in each cell to form the 928-dimensional LBP descriptor. After that, the appearance descriptor is augmented by the coordinates of the patch center to build the spatial-appearance descriptor. The values of coordinates are between 0 and 1 with the top-left corner as the origin. And in our experiments, the coordinates values are scaled by 2 before the spatial augmentation. Over all training data, we trained a PEP-model of 1024 spherical Gaussian components. For APEM, given a pair of face images, all descriptors in the joint descriptor set are utilized for joint adaptation. After calculating matching difference vectors, we trained an SVM classifier using RBF kernel for classification. We followed the standard 10-folds cross-validation over View 2 to report our performance, and we never use the View 1 dataset. We note that more dense local descriptor extraction is conducted in this experiments when compared with the setting in [27], which leads to higher verification accuracy.

### 6.2.3 Results

As shown in Table 1 and FIG. 10, our methods perform comparable to the state-of-the-art. We demonstrated the effectiveness of the PEP-model by comparing with the baseline and we also observed joint Bayesian adaptation and multiple features fusion bring consistent improvements. Furthermore, our approach on unaligned faces [14], which are the direct outputs of the Viola-Jones face detector, even outperformed methods with faces aligned by the funneling method.

TABLE 1
Performance comparison on the most restricted LFW

| Algorithm | Accuracy ± Error(%) |
|---|---|
| Nowak [45] | 73.93 ± 0.49 |
| Hybrid descriptor-based [46] | 78.47 ± 0.51 |
| V1/MKL [8] | 79.35 ± 0.55 |
| Fisher vector faces [39] | 87.47 ± 1.49 |
| Baseline (fusion, setting as in [27]) | 77.30 ± 1.59 |
| APEM (fusion, setting as in [27]) | 84.08 ± 1.20 |
| PEM (LBP) | 83.78 + 1.65 |
| PEM (SIFT) | 84.03 ± 1.05 |
| PEM (fusion) | 85.57 ± 0.73 |
| APEM (LBP) | 84.63 ± 1.39 |
| APEM (SIFT) | 84.37 ± 0.74 |
| APEM (fusion) | 86.10 ± 1.09 |
| PEM (SIFT, without flipping) | 82.08 ± 1.02 |
| PEM (SIFT, unaligned) | 83.05 ± 1.19 |

Comparing to the baseline algorithm without using PEP-model, the performance improvement could be justified as the PEP-representations alleviated pose variations as shown in FIG. 6(b). With horizontally flipping we can further improve the to verification accuracy with an intuitive explanation (FIG. 6(c)) that the flipped faces complement the occluded facial parts which produce more pose robust PEP-representations. The best verification accuracy we achieved so far is 86.10±1.09%, which is slightly inferior to the current state-of-the-art, i.e., 87.47±1.49% reported in [39].

### 6.3 YouTube Faces Dataset

This work is a general framework which can handle both image and video based face verification without modification. Wolf et al. [15] published YouTube Faces Dataset (YTFaces) for studying the problem of unconstrained face recognition in videos. The dataset contains 3,425 videos of 1,595 different people. On average, a face track from a video clip consists of 181.3 frames of faces. Faces are detected by the Viola-Jones detector and aligned by fixing the coordinates of automatically detected facial feature points [15]. Protocols are similar to LFW, for the same purpose, we focus on the restricted video face verification paradigm.

### 6.3.1 Settings

In the video faces experiments, each image frame is center cropped to 100×100. Then descriptors are extracted in the same way in Section 6.2.2 for each frame. For each video, for efficiency, we randomly sampled 10 frames as the face track. In the stage of joint Bayesian adaptation, to ease the computational intensity, 10% descriptors are sampled randomly from each face track to be combined into the joint descriptor set.

TABLE 2
Performance comparison over YouTube Faces

| Algorithm | Accuracy ± Error(%) |
|---|---|
| MBGS [15] | 76.4 ± 1.8 |
| MBGS+SVM− [17] | 78.9 ± 1.9 |
| STFRD+PMML [40] | 79.5 ± 2.5 |
| VSOF+OSS(Adaboost) [47] | 79.7 ± 1.8 |
| PEM (LBP) | 79.62 ± 1.71 |
| PEM (SIFT) | 79.78 ± 1.98 |
| PEM (fusion) | 80.60 ± 1.80 |
| APEM (LBP) | 79.82 ± 1.65 |
| APEM (SIFT) | 80.26 ± 1.96 |
| APEM (fusion) | 81.36 ± 1.98 |

### 6.3.2 Results

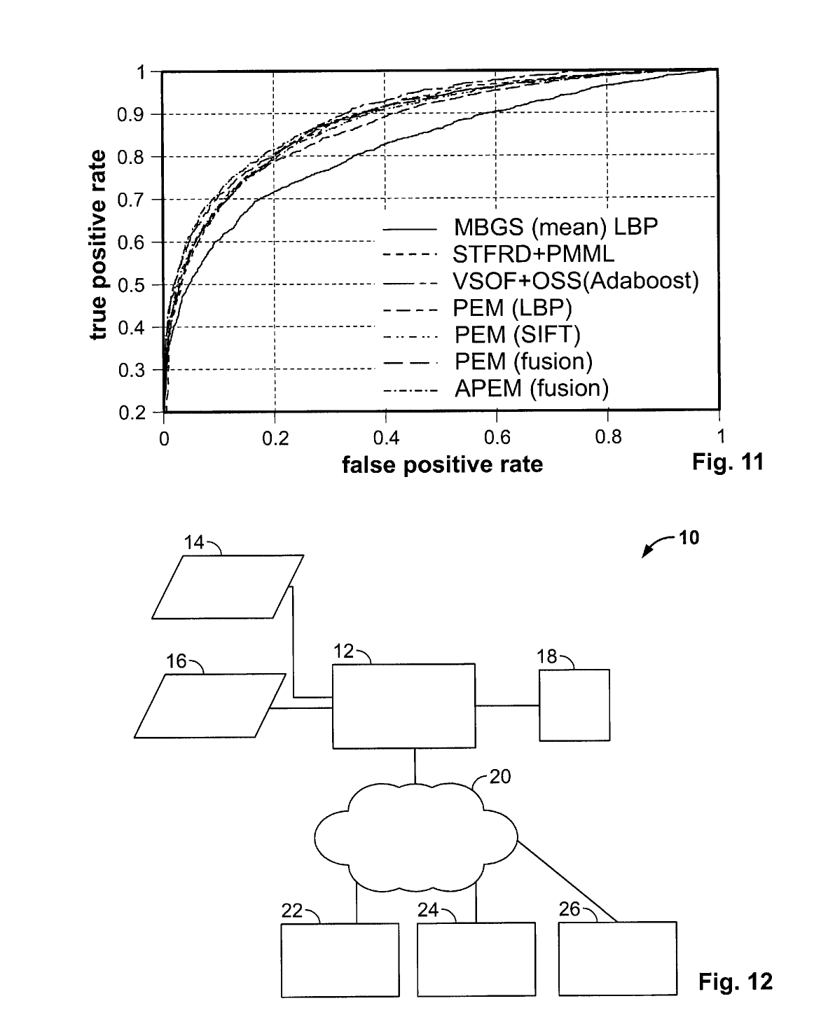

As shown in Table 2 and FIG. 11, at the low false positive rate area which is the common operation point in practical applications, our method outperformed the state-of-the-art algorithms with a large margin. As shown in FIG. 6(d), frames in the video could be complementary to each other. By adding more frames, the PEP-representation evolved to be more like a neural face representation by making use of frames from different viewpoints. It can reasonable to assume that using more frames for each face track, we can further improve the verification accuracy at the cost of extra computational expense. Overall, we achieved the state-of-the-art verification accuracy of 81.36±1.98%, which outperformed the previous best result 79.7±1.8% reported in [47].

### CONCLUSION

In this paper, we proposed a probabilistic elastic part model to build pose-invariant probabilistic elastic part representation, with an additional joint Bayesian adaptation component as a general framework for both image and video based face verification. Extensive experiments were performed in which PEM/APEM achieved state-of-the-art performance on two standard face verification benchmark datasets, most restricted LFW and restricted YouTube Faces dataset.

### ACKNOWLEDGMENTS

This work is supported by US National Science Foundation Grant IIS-1350763, a Google Research Faculty Award, gift grants from both Adobe Research and NEC Labs, and Stevens Institute of Technology faculty startup funds for Gang Hua.

FIG. 12 shows a system 10 having a computer 12 that can be used to implement the facial recognition methodology described above. The computer 12 may be a main frame, a micro-computer such as a PC, a laptop, hand-held computer or a smart phone. The volume of digital image data to be processed and the speed in which it is required to be processed may impact hardware requirements. The computer 12 may receive image data from external hardware devices 14, such as hard disks, thumb drives, camera or video storage media cards, a digital video or digital camera feed which dynamically captures and shares image data from a live scene, e.g., an airport terminal or street scene. The computer 12 may download the image data as a batch file read or via periodic sampling, e.g., in the case of a live feed. After processing the image data, e.g., in the form of pairs of images from a database of images of persons of interest, the resultant PEP models may be stored either in the internal memory of the computer 12 or externally on a high volume data storage device 16, which may alternatively be a back-up storage device to store the resultant model as a backup or redundant data storage device. The raw image data may be stored on devices 14 and or 16. In addition, the computer 12 is connected to a display and I/O device 18 by which is may present the raw and processed image data, including identification and classification conclusions to a human observer and through which the human observer can interact with and control the programmed computer 12. The computer 12 may be connected via a network 20 to any number of other computers 22, 24, 26 with which it may share image input or output data and or with which it may execute the methods described above, e.g., in a shared/distributed or redundant, independent processing approach. The computers 22, 24, 26 in the network 20 may also have raw image data input and processed image data output which may be shared with one another and with computer 12, such that each computer may build and share a commonly accessible image database.

In this disclosure, various functions and operations may be described as being performed by or caused programmatically by software code. Those skilled in the art will recognize that the functions and calculations described above result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA).

A machine readable medium can be used to store software and data which when executed by a computer, e.g., the microprocessor thereof, causes the computer to perform methods disclosed above. The executable software and data may be stored in various places including for example ROM, volatile RAM, non-volatile memory, a server, a network and/or cache. The data and instructions required to carry out the above-described methods can be obtained in their entirety prior to execution of the method steps. Alternatively, portions of the data and instructions can be obtained dynamically, just in time, when needed for execution.

The computer-readable media may store the program instructions. In general, a tangible machine readable medium includes any mechanism that provides (i.e., stores and/or transmits) information in a form accessible by a machine (e.g., a computer, network device, personal digital assistant, etc.).

### REFERENCES

[1] V. Jain, A. Ferencz, and E. Learned-miller, “Discriminative training of hyper-feature models for object identification,” in BMVC, pp. 357-366, 2006.
[2] S. Yan, X. Zhou, M. Liu, M. Hasegawa-Johnson, and T. Huang, “Regression from patch-kernel,” in CVPR, 2008.
[3] S. Yan, M. Liu, and T. Huang, “Extracting age information from local spatially flexible patches,” in ICASSP, 2008.
[4] M. A. Turk and A. P. Pentland, “Face recognition using eigenfaces,” in CVPR, 1991.
[5] P. N. Belhumeur, J. P. Hespanha, and D. J. Kriegman, “Eigenfaces vs. Fisherfaces: Recognition using class specific linear projection,” T-PAMI, 1997.
[6] A. S. Georghiades, P. N. Belhumeur, and D. J. Kriegman, “From few to many: Illumination cone models for face recognition under variable lighting and pose,” T-PAMI, 2001.
[7] T. Ahonen, A. Hadid, and M. Pietikainen, “Face recognition with local binary patterns,” in ECCV, 2004.
[8] N. Pinto, J. J. DiCarlo, and D. D. Cox, “How far can you get with a modern face recognition test set using only simple features?,” in CVPR, 2009.
[9] J. Wright and G. Hua, “Implicit elastic matching with randomized projections for pose-variant face recognition,” in CVPR, 2009.
[10] G. Hua and A. Akbarzadeh, “A robust elastic and partial matching metric for face recognition,” in ICCV, 2009.
[11] N. Kumar, A. Berg, P. N. Belhumeur, and S. Nayar, “Describable visual attributes for face verification and image search,” T-PAMI, 2011.
[12] L. Wolf, T. Hassner, and Y. Taigman, “Effective unconstrained face recognition by combining multiple descriptors and learned background statistics,” T-PAMI, 2011.
[13] D. Chen, X. Cao, L. Wang, F. Wen, and J. Sun, “Bayesian face revisited: A joint formulation,” in ECCV, 2012.
[14] G. B. Huang, M. Mattar, T. Berg, and E. Learned-Miller, “Labeled Faces in the Wild: A Database forStudying Face Recognition in Unconstrained Environments,” in Faces in Real-Life Images Workshop in ECCV, 2008.
[15] L. Wolf, T. Hassner, and I. Maoz, “Face recognition in unconstrained videos with matched background similarity,” in CVPR, 2011.
[16] D. Chen, X. Cao, F. Wen, and J. Sun, “Blessing of dimisionality: High dimensional feature and its efficient compression for face verification.,” in CVPR, 2013.
[17] L. Wolf and N. Levy, “The svm-minus similarity score for video face recognition.,” in CVPR, 2013.
[18] N. Kumar, A. C. Berg, P. N. Belhumeur, and S. K. Nayar, “Attribute and simile classifiers for face verification,” in ICCV, 2009.
[19] T. Berg and P. Belhumeur, “Tom-vs-pete classifiers and identitypreserving alignment for face verification,” in BMVC, 2012.
[20] U. Prabhu, J. Heo, and M. Savvides, “Unconstrained poseinvariant face recognition using 3d generic elastic models,” TPAMI, vol. 33, no. 10, pp. 1952-1961, 2011.
[21] Q. Yin, X. Tang, and J. Sun, “An associate-predict model for face recognition,” in CVPR, 2011.
[22] Z. Cao, Q. Yin, X. Tang, and J. Sun, “Face recognition with learning-based descriptor,” in CVPR, 2010.
[23] G. B. Huang, M. J. Jones, and E. Learned-Miller, “Lfw results using a combined nowak plus merl recognizer,” in Faces in Real-Life Images Workshop in ECCV, 2008.
[24] L. Liang, R. Xiao, F. Wen, and J. Sun, “Face alignment via component based discriminative search,” in ECCV, 2008.
[25] X. Cao, Y. Wei, F. Wen, and J. Sun, “Face alignment by explicit shape regression,” in CVPR, 2012.
[26] X. Xiong and F. D. la Torre, “Supervised descent method and its applications to face alignment,” in CVPR, 2013.
[27] H. Li, G. Hua, Z. Lin, J. Brandt, and J. Yang, “Probabilistic elastic matching for pose variant face verification,” in CVPR, 2013.
[28] S. Arashloo and J. Kittler, “Energy normalization for poseinvariant face recognition based on mrf model image matching,” T-PAMI, vol. 33, no. 6, pp. 1274-1280, 2011.
[29] P. Felzenszwalb and D. Huttenlocher, “Pictorial structures for object recognition,” IJCV, 2005.
[30] D. G. Lowe, “Distinctive image features from scale-invariant keypoints,” IJCV, 2004.
[31] T. Hasan and J. Hansen, “A study on universal background model training in speaker verification,” Audio, Speech, and Language Processing, IEEE Transactions on, 2011.
[32] P. Viola and M. J. Jones, “Robust real-time face detection,” IJCV, 2004.
[33] X. Zhou, N. Cui, Z. Li, F. Liang, and T. Huang, “Hierarchical gaussianization for image classification,” in ICCV, 2009.
[34] M. Dixit, N. Rasiwasia, and N. Vasconcelos, “Adapted gaussian models for image classification,” in CVPR, 2011.
[35] R. Gross, J. Yang, and A. Waibel, “Growing gaussian mixture models for pose invariant face recognition,” ICPR, 2000.
[36] X. Wang and X. Tang, “Bayesian face recognition based on gaussian mixture models,” in ICPR, 2004.
[37] D. Cox and N. Pinto, “Beyond simple features: A large-scale feature search approach to unconstrained face recognition,” in FGR, 2011.
[38] F. Wang and L. J. Guibas, “Supervised earth mover's distance learning and its computer vision applications,” in ECCV, 2012.
[39] K. Simonyan, O. M. Parkhi, A. Vedaldi, and A. Zisserman, “Fisher Vector Faces in the Wild,” in BMVC, 2013.
[40] C. Zhen, W. Li, D. Xu, S. Shan, and X. Chen, “The svm-minus similarity score for video face recognition.,” in CVPR, 2013.
[41] J.-L. Gauvain and C.-H. Lee, “Maximum a posteriori estimation for multivariate gaussian mixture observations of markov chains,” T-SAP, 1994.
[42] C.-C. Chang and C.-J. Lin, “LIBSVM: A library for support vector machines,” ACM T-IST, 2011.
[43] G. Huang, V. Jain, and E. Learned-Miller, “Unsupervised joint alignment of complex images,” in ICCV, 2007.
[44] A. Vedaldi and B. Fulkerson, “Vlfeat: an open and portable library of computer vision algorithms,” in ACM Multimedia, 2010.
[45] E. Nowak and F. Jurie, “Learning visual similarity measures for comparing never seen objects,” in CVPR, 2007.
[46] L. Wolf, T. Hassner, and Y. Taigman, “Descriptor based methods in the wild,” in Faces in Real-Life Images Workshop in ECCV, 2008.
[47] H. Mendez-Vazquez, Y. Martinez-Diaz, and Z. Chai, “Volume structured ordinal features with background similarity measure for video face recognition,” 2013.

We claim:

1. A method for automatically categorizing a first digital image of a person and a second digital image of a person as either images of the same person or different persons using a computer programmed with digital processing software, comprising the steps of:
(A) receiving the first digital image in the programmed computer as input to the digital processing software, the digital processing software
(B) partitioning the first digital image into a plurality of sub-parts, each having a plurality of pixels and a location relative to the first digital image, each pixel having a value corresponding to the appearance thereof on a scale of visual values;
(C) for each of the plurality of sub-parts of the digital image, extracting a local descriptor based upon the appearance of the sub-part;
(D) augmenting each local descriptor with its location in the first digital image, transforming the first image into a set of spatial-appearance descriptors;
(E) identifying one descriptor from the set of spatial-appearance descriptors to describe each part in a maximum likelihood sense;
(F) concatenating the appearance parts in the spatial-appearance descriptors in an order of the location components to build a probabilistic elastic part (PEP) representation of the first digital image;
(G) performing steps A-F for the second digital image;
(H) calculating a similarity measure between the PEP representations of the first digital image and the second digital image to quantify the degree of similarity between the first image and the second image.

2. The method of claim 1, wherein the plurality of sub-parts are overlapping.

3. The method of claim 1, further including the step of reproducing the first digital image at a plurality of scales

4. The method of claim 1, wherein the local descriptor is a Local Binary Pattern (LBP)

5. The method of claim 1, wherein the local descriptor is a scale-invariant feature transform (SIFT).

6. The method of claim 1, wherein the visual values are greyscale values.

7. The method of claim 1, wherein the first digital image and the second digital image are facial images.

8. The method of claim 1, wherein the first digital image is a set of digital images and the steps A-F are conducted for each of the set of digital images.

9. The method of claim 8, wherein the set of digital images are a plurality of frames from a video clip.

10. The method of claim 1, wherein the first digital image includes a plurality of digital images and further including the step of training a Gaussian mixture model (GMM) with the spatial-appearance descriptors from the plurality of digital images.

11. The method of claim 10, wherein the each mixture component of the GMM is constrained to be a spherical Gaussian.

12. The method of claim 11, wherein the spherical Gaussians balance the impact of appearance and spatial location.

13. The method of claim 1, further comprising the steps of obtaining a training set of images containing matching and non-matching facial image pairs;
training an SVM classifier on the difference vectors associated with the training set of images;
subsequently receiving new digital images into the computer; and
distinguishing digital images of persons that match images of persons in the training set from digital images of persons that do not match images of persons in the htraining set.

14. The method of claim 1, further comprising the step of classifying the first image as either the same person as a person appearing in the second image or a different person based upon the quantified similarity between the first image and the second image.

15. The method of claim 1, wherein the first digital image is a plurality of digital images of a single person.

16. The method of claim 15, wherein the plurality of digital images of the single person are images having differences in at least one of scale, pose, illumination or facial expression.

17. The method of claim 1, further comprising applying a joint Bayesian adaptation to adapt the PEP-model to better fit the features of the pair of faces/face tracks by Bayesian maximum a posteriori parameter estimation.

18. The method of claim 1, wherein parameters of the PEP model may be learned using Expectation-Maximization (EM) from densely extracted spatial-appearance local descriptors from training face images.

19. The method of claim 1, further including the step of constructing a horizontally flipped face image to be computed inot the PEP representation.

20. The method of claim 1, wherein the step of calculating a similarity measure is by training an SVM on top of an element-wise absolute difference vector of the PEP representations between the first digital image and the second digital image.
